(19) United States
(12) Patent Application Publication
(10) Pub. No.: US 2007/0048690 A1
(43) Pub. Date: Mar. 1, 2007

(54) Simulated convex mirrors for driving simulators

(75) Inventors: Michael P. Stricek, Binghamton, NY (US); Carl J. Wenzinger, Binghamton, NY (US)

Correspondence Address: BROWN & MICHAELS, PC;400 M & T BANK BUILDING, 118 NORTH TIOGA ST, ITHACA, NY, 14850, US

(73) Assignee: Doron Precision Systems, Inc., Binghamton, NY (US)

(21) Appl. No.: 11/212,234

(22) Filed: Aug. 26, 2005

(51) Int. Cl. G09B 9/02

(52) U.S. Cl. 434/29

(57) ABSTRACT

The invention provides an enhanced computer simulator for large vehicles, in which simulated convex mirrors are provided, inset into side displays adjacent to simulated flat side-view mirrors. The right- and left-hand mirror groups are independently adjustable, and the convex mirror images are configured to show a wide-angle version of the rear view shown by the adjacent flat image.

### BACKGROUND OF THE INVENTION

1. Field of the Invention

The invention pertains to the field of vehicle simulators. More particularly, the invention pertains to interactive simulators for large vehicles using computer-generated imagery.

2. Description of Related Art

Perhaps the greatest challenge facing commercial vehicle drivers is limited field of vision of the environment surrounding their vehicle. Operators need to be aware of all of their surroundings, both in front of the vehicle and beside or behind it.

This problem has been substantially reduced through rear view mirror designs that significantly and effectively increase the field of view around the vehicle. The most common solution is comprised of a combination of two types of mirrors, many times within the same housing. One of these mirrors is the typical “flat” mirror, the second a “convex” mirror. The convex mirror provides the driver a wider field of vision and has been found very useful on both left and right side of the vehicle. The left is helpful in entering traffic from a parked position, changing lanes and negotiating left turns. The right side is very helpful in changing lanes, parking and making right turns (reducing the “right turn squeeze”) in both long vehicles, (buses and trucks) and articulated vehicles such as tractor-trailers. The right side convex mirror on buses helps reduce passenger accidents when embarking or disembarking involving pedestrians who are too close to the bus during a right turn.

Remote controlled motorized mirrors have become more common with transit agencies and particularly on the right (curb side) since it is more difficult to properly adjust. A driver in a hurry is likely to not take the time to properly adjust a manually adjustable mirror. The remote controlled motorized mirror greatly reduces this tendency, thus improving safety. TCRP Report 66 (2001) (Pages 41 and 42) references some transit systems that report “highly effective safety improvements in driver vision and mirrors on buses” listing a few that use remote controlled, convex (and/or heated) mirrors. Even with the provision of dual mirrors and remote control facilities, operators of large vehicles such as buses, trucks and emergency vehicles have found that drivers need training in the proper adjustment and use of the mirrors to use them consistently and properly.

Simulators for driver training have existed for many years, first in the automobile “driver ed” field, and later on for large vehicles such as buses and trucks. Trainers have also become aware in recent years that it is important that the use of mirrors is increasingly of concern to large vehicle operators and insurers, and it is important that the simulation should emulate the real mirrors used on these vehicles as closely as possible.

U.S. Pat. No. 2,935,794, “Automobile Driver Training and Testing Apparatus”, shows a group driver-training simulator with a real mirror attached to the back of each “vehicle”—the student can look in the mirror, which reflects a rear-facing image in the front projector screen to simulate “looking over the shoulder as for lane changes.”

U.S. Pat. No. 4,846,686, “Motor Vehicle Simulator with Multiple Images”, shows a semi-interactive simulator with side-view “mirror” images on each side of the main projected image showing a rear-facing view. The simulator shown in this patent used a film projector, as was the state of the art at the time. As can be seen in FIG. 4, the side-view images (41LM-45LM), (41RM-45RM) are photographically composited using conventional photographic darkroom techniques with the main forward image (41POV-45POV) on each frame (41-45) of the film.

Some current interactive large-vehicle simulators have used the same approach, by providing real mirrors outside the cab of the simulator, reflecting a view from a separate screen located behind the simulator. While this approach works acceptably for flat mirrors, it presents a problem for convex mirrors because it is not practical to provide a rear-mounted display which is large enough to cover the entire wide-angle field of view of the mirror. Also, this approach requires the expense of an additional pair of large displays and the cost in terms of computing overhead to generate the images to drive the displays.

Doron Precision Systems, assignee of this application, developed the feature of having rear-view mirrors for its interactive commercial vehicle simulators. These simulators have provided imbedded images for the flat mirrors at the correct relative location in the appropriate vehicle simulated window, as was first introduced in Doron's Vehicle Maneuvering Trainer (VMT) in 1990, which received U.S. Pat. No. 5,015,189. That system used TV cameras mounted upon a model truck, which maneuvered around a real (miniaturized) area under remote control by a driver trainee in a full-size truck cab.

As technology has progressed, commercial trainers have replaced the film and film projectors and electronic projectors showing images from videotape (and cameras on model vehicles, as in U.S. Pat. No. 5,015,189) with fully interactive simulations of computer-generated video “worlds”, where the driver can drive the simulated vehicle within the limits of the simulated area and one or more computers generate the view out of the windows of the truck or bus.

FIG. 1 shows such a simulator, in a Fire Truck version. As can be seen in the figure, the simulator provides a near-life-size cab (1), in which is mounted a driver position (6) comprising a steering wheel, foot pedals, control consoles, etc., which mimics the actual vehicle as closely as possible. A passenger seat might be included for a trainer or observer, or other features appropriate to the vehicle being simulated, such as passenger doors and a cash box for a bus, etc.

Large displays such as flat-panel or projection displays are arranged in front and to the sides of the cab (1) to present a simulated world outside the windows of the cab, generated by a network of computers (7). In the version shown in FIG. 1, there are four such displays: two displays in front of the “windshield” (3) and (4), and a left display (2) and right display (5), at about a 45° angle to the front displays, which show a view obliquely out the “side windows” of the cab (1). Simulated left (8) and right (9) flat side-view mirrors are imbedded in the side displays (2) and (5), respectively.

U.S. Pat. No. 5,184,956, “Method and Device for Training in the Driving of Vehicles” is a computer driving simulator, in which rear- and side-view mirror images are created as sub-images inset into portions of simulation. The sub-images 22 and 23 for the side-view mirrors are then reflected by mirrors 27 and 28 (inside the dashboard) into physical side-view mirrors 25 and 26. “In accordance with another embodiment, steps can also be taken to replace the rear-view mirrors 20, 25 and 26 by additional screens corresponding in size to the rear-view mirrors and to generate the corresponding rear vision images directly on these screens.” FIG. 5 of the '956 patent shows an embodiment with three full-size screens for wider field of view, as used in DORON simulators. “In this variant, steps can be taken to dispense with the lateral rear-view mirrors 25 and 26 and to insert the rear vision secondary images 22 or 23 into the bottom portion of the screen 38 or 39.

U.S. Pat. No. 5,764,232, “Three-Dimensional Simulator Apparatus and Image Synthesis Method” is a driving simulator using inset simulated flat mirrors which images are more compressed than the image on the main screen, so it is represented at a lower detail than the main screen.

### SUMMARY OF THE INVENTION

The invention provides an enhanced computer simulator for large vehicles, in which simulated convex mirrors are provided, inset into side displays adjacent to simulated flat side-view mirrors. The right- and left-hand mirror groups are independently adjustable, and the convex mirror images are configured to show a wide-angle version of the rear view shown by the adjacent flat image.

### BRIEF DESCRIPTION OF THE DRAWING

FIG. 1 shows a picture of a prior-art simulator

FIG. 2 shows a large-vehicle simulator incorporating the invention

FIG. 3 shows an actual image from a left-side simulator display, showing the inset mirror images

FIG. 4 shows an actual image from a right-side simulator display, showing the inset mirror images

FIG. 5 shows the system of the invention in block form.

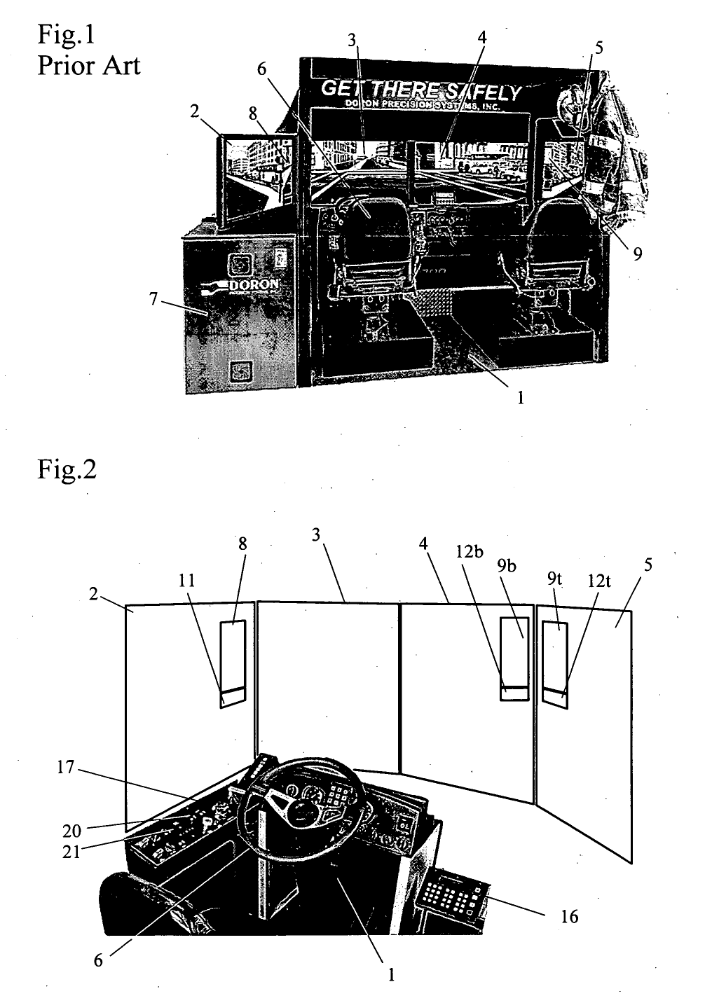

### DETAILED DESCRIPTION OF THE INVENTION

FIG. 2 shows a large-vehicle simulator according to the teachings of the invention. The simulator cab (1) has a driver position (6) including the steering wheel, instruments, pedals, and whatever controls might be appropriate to the vehicle being simulated. In the embodiment shown in FIG. 2, a transit bus is simulated, so the simulator includes a fare box or ticket printer (16) and a left-side console (17) having door operating controls, etc. The console (17) also has left- (20) and right-side (21) mirror remote controls, as will be discussed below.

In front and to the sides of the driver position (6) are a plurality of large displays—in this example, shown as left-side display (2), two front displays (3) and (4), and right-side display (5). These displays show computer-generated views of a virtual world through which the vehicle will travel, arranged so as to present a realistic view from the cab. It will be understood that other numbers of displays may be used, consistent with the requirements of the vehicle being simulated—a single front display, for example, can be used in smaller vehicles, and projected video images could replace the physical displays.

There is an imbedded image of the large flat side-view mirror (8) on the left display (2), as has been used in prior art simulators. Similarly, a right flat side-view mirror image (9b) is imbedded on the right-hand front display (4) for bus simulators, or (9t) on the right display (5) for truck simulators, representing the different placement of right-hand mirrors on trucks and buses. These flat mirror images (8) and (9b/9t) present an undistorted view to the rear, at an angle set by the mirror remote controls (20) and (21), simulating the large flat mirrors on real vehicles.

The simulator of the invention adds a second imbedded mirror image to the flat images in the simulated displays. These are shown at (11) on left display (2) for the left-hand image and a right-hand image on right-front display (4) at (12b) for a bus or on right display (5) at (12t) for a truck. These images are placed in their display adjacent to the simulated flat mirrors (8) and (9b/9t), respectively, and are aimed together with the flat mirrors by the remote controls (20) and (21) on the console (17). Thus, each pair of images, left- and right-hand, are aimed together, but independently of the images on the other side. The image shown in the second mirrors (11) and (12b/12t) faces to the rear, but shows a much wider angle than the imbedded image, simulating the convex mirrors in use on an actual vehicle.

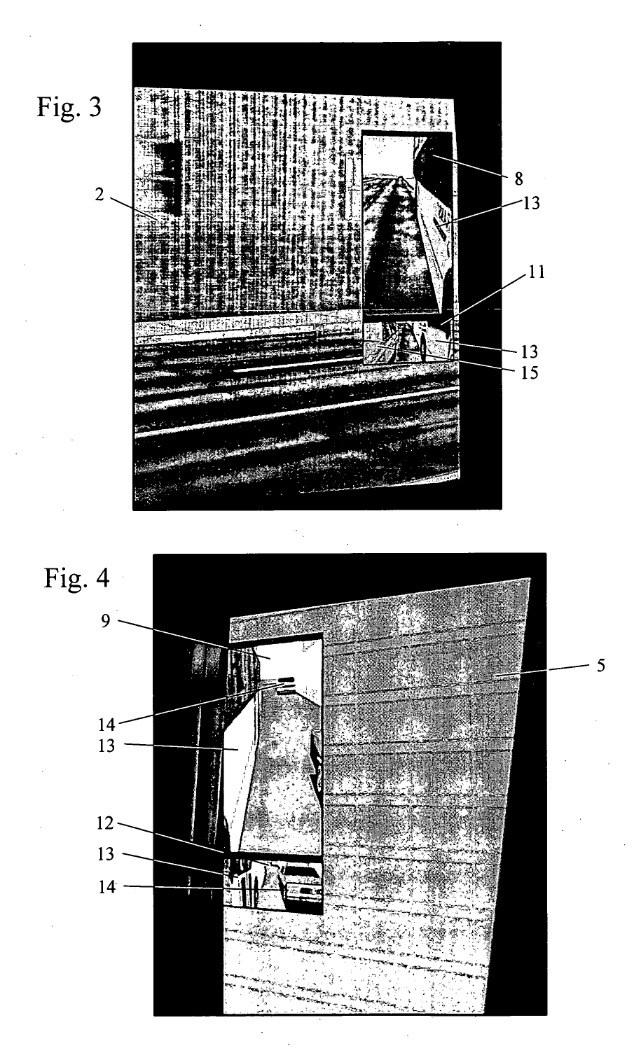

FIGS. 3 and 4 show a left and right simulated image according to the teachings of the invention.

As can be seen in FIG. 3, the flat mirror image (8) shows an undistorted rear view along the side of the simulated bus (13). The second image (11) covers a much wider angle view, and shows both the side of the bus (13) and a car (15) in the driver's blind spot alongside the bus.

FIG. 4 shows the right view, with the flat mirror image (9) showing an undistorted rear view along the bus (13). A car (14) in the driver's right-hand blind spot is barely visible in the simulated flat mirror (9), but clearly visible in the wide-angle second image (12).

The second images (11) and (12) may be simulated with a true convex-mirror distortion, or, as shown in the figures, with simply a very wide angle view simulating the view of a convex mirror, without the vertical distortion introduced by true convex mirrors.

Because the mirror images are remotely controlled, the simulator of the invention can be programmed such that the mirrors are initially misadjusted. This requires the trainee to properly adjust the mirrors before starting. Scenarios can then be run in which the driver can get into an accident with an unseen simulated vehicle such as cars (12) or (15) if he had neglected to properly adjust the mirrors (8)(9)(11) and (12). Thus, the simulator can help train drivers of large vehicles to develop the habits not only of using their side-view mirrors properly, but also of adjusting them correctly.

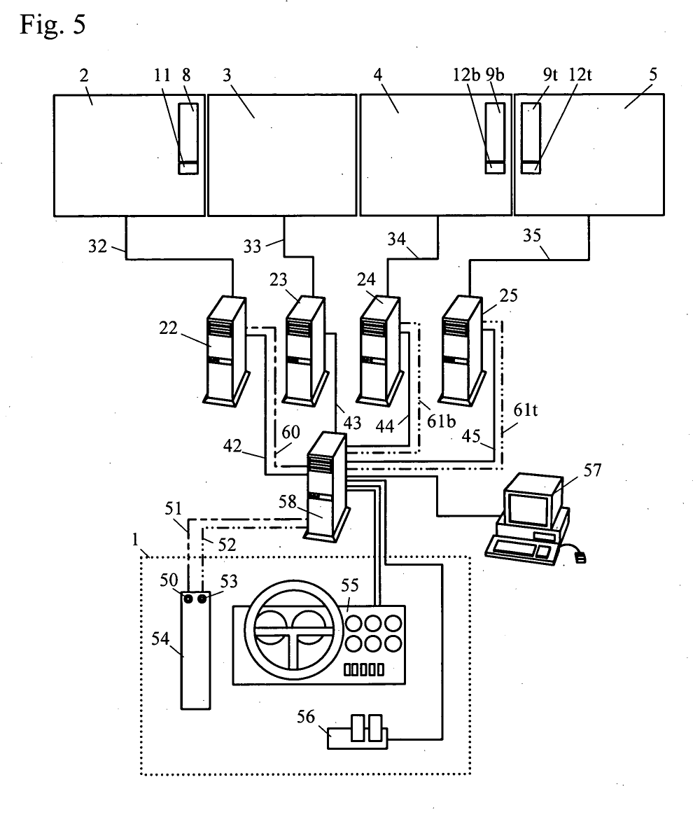

FIG. 5 shows a block diagram of the entire simulation system of the invention, showing the cab (1) with driver's console (55) and pedal unit (56), and the side console (54) with remote-control switches (50) and (53). Displays (2), (3), (4) and (5) show the imbedded flat mirror images (8) and (9b/9t), and second wide angle/convex mirrors (11) and (12b/12t).

An instructor console (57) provides the trainer with control over the simulation, allowing selection of scenarios, control of time of day, weather and visibility, and setup of different vehicles. By simple software selection and rolling in of an appropriate driver's consoles (55), the simulator may be quickly and easily switched from a transit bus with mirrors at (9b) and (12b) to a fire engine or over-the-road truck with mirrors at (9t) and (12t). At the same time, the simulator will switch vehicle characteristics to match the vehicle chosen.

A main computer (58) coordinates the simulation system, networked with separate video display computers (22), (23), (24) and (25), each of which drives the display on its own video display (2), (3), (4) and (5) through lines (32), (33), (34) and (35).

As is shown schematically by dashed/dotted lines, the left remote mirror control (50) sends commands (51) about the aiming of the left-hand mirrors (8)(11) to the main computer (58), which sends the imbedded image information (60) to left display computer (22), which, in turn, incorporates the imbedded images into the display it generates on left-hand display (2). Similarly, the right remote mirror control (53) sends commands (52) about the aiming of the right-hand mirrors (9)(12) to the main computer (58), which, if it is set to simulate a bus, sends the imbedded image information (61b) to right-front display computer (24), which, in turn, incorporates the imbedded images (9b)(12b) into the display it generates on right-front display (4). If the computer (58) is set to simulate a truck or ambulance or the like, it sends the imbedded image information (61t) to right-side display computer (25), which, in turn, incorporates the imbedded images (9t)(12t) into the display it generates on right-side display (5).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An interactive driving simulator for vehicles, including:
a) a driver position having controls for the vehicle, the controls including a mirror remote control;
b) a left-hand screen display located so as to present a simulated view from at least a left-side cab window of the vehicle;
c) a right-hand screen display located so as to present a simulated view from at least a right-side cab window of the vehicle;
d) at least one front screen display located so as to present a simulated view from at least a windshield of the vehicle;
e) a computer system coupled to the driver position, the left-hand screen display, the right-hand screen display, and the front screen display, programmed to present images on the left-hand screen display, right-hand screen display and front display simulating for a driver located at the driver position, views from the cab of the vehicle in a driving situation;
f) an image simulating a left-hand side-view flat mirror, imbedded in the image on the left-hand screen display, simulating a view to the rear of the vehicle along the left side of the vehicle;
g) an image simulating a left-hand convex mirror, imbedded in the image on the left-hand screen display adjacent to the simulated left-hand flat side-view mirror, showing a wider angle view to the rear of the vehicle than the view in the adjacent simulated flat mirror;
h) an image simulating a right-hand side-view flat mirror, imbedded in an image on a screen display, simulating a view to the rear of the vehicle along the right side of the vehicle;
i) an image simulating a right-hand convex mirror, imbedded in the image on the adjacent to the simulated right-hand side-view flat mirror, showing a wider angle view to the rear of the vehicle than the view in the adjacent simulated flat mirror;
the computer being programmed such that the views in the left-hand simulated side-view mirrors and right-hand simulated side-view mirrors are separately alterable in response to driver inputs on the mirror remote control at the driver position.

2. The driving simulator of claim 1, in which the vehicle is a bus, and the simulated right-hand mirror images are imbedded in the image on at least one front screen display.

3. The driving simulator of claim 1, in which the vehicle is a truck, and the simulated right-hand mirror images are imbedded in the image on the right-hand screen display.

4. The driving simulator of claim 1, in which the mirror remote control comprises separate left-hand and right-hand mirror remote control switches.

5. The driving simulator of claim 1, in which the images in the left-hand side-view flat mirror and left-hand convex mirror are altered together.

6. The driving simulator of claim 1, in which the images in the right-hand side-view flat mirror and right-hand convex mirror are altered together.

7. An improved interactive driving simulator for vehicles of the type having a driver position having controls for the vehicle, the controls including a mirror remote control; a left-hand screen display located so as to present a simulated view from at least a left-side cab window of the vehicle; a right-hand screen display located so as to present a simulated view from at least a right-side cab window of the vehicle; at least one front screen display located so as to present a simulated view from at least a windshield of the vehicle; a computer coupled to the driver position, the left-hand screen display, the right-hand screen display, and the front screen display, programmed to present images on the left-hand screen display, right-hand screen display and front display simulating for a driver located at the driver position, views from the cab of the vehicle in a driving situation; a simulated left-hand side-view flat mirror imbedded in the image on the left-hand screen display, simulating a view to the rear of the vehicle along the left side of the vehicle and a simulated right-hand side-view flat mirror imbedded in an image on a screen display, simulating a view to the rear of the vehicle along the right side of the vehicle; the improvement including:
a simulated left-hand convex mirror, imbedded in the image on the left-hand screen display adjacent to the simulated left-hand flat side-view mirror, showing a wider angle view to the rear of the vehicle than the view in the adjacent simulated flat mirror; and
a simulated right-hand convex mirror, imbedded in the image adjacent to the simulated right-hand side-view flat mirror, showing a wider angle view to the rear of the vehicle than the view in the adjacent simulated flat mirror.

8. The driving simulator of claim 7, further including in which the computer is programmed such that the views in the left-hand simulated side-view mirrors and right-hand simulated side-view mirrors are separately alterable in response to driver inputs on the mirror remote control at the driver position.

9. The driving simulator of claim 8, in which the images in the left-hand side-view flat mirror and left-hand convex mirror are altered together.

10. The driving simulator of claim 8, in which the images in the right-hand side-view flat mirror and right-hand convex mirror are altered together.

11. The driving simulator of claim 8, in which the mirror remote control comprises separate left-hand and right-hand mirror remote control switches.

12. The driving simulator of claim 7, in which the vehicle is a bus, and the simulated right-hand mirror images are imbedded in the image on at least one front screen display.

13. The driving simulator of claim 7, in which the vehicle is a truck, and the simulated right-hand mirror images are imbedded in the image on the right-hand screen display.
